(19) United States
(12) Patent Application Publication
(10) Pub. No.: US 2025/0192310 A1
(43) Pub. Date: Jun. 12, 2025

(54) TRACTION BATTERY PACK STRUCTURAL CROSS-MEMBER ASSEMBLIES WITH TENSILE AND COMPRESSION LOAD CARRYING CAPABILITY

(71) Applicant: FORD GLOBAL TECHNOLOGIES, LLC, Dearborn, MI (US)

(72) Inventors: Deanna Marie Winton HOFFMAN, Ann Arbor, MI (US); Alex REVELS, Canton, MI (US); Kanchana PERUMALLA, Troy, MI (US); Mohammadreza EFTEKHARI, Novi, MI (US); Michael E. REIBLING, Sterling Heights, MI (US)

(21) Appl. No.: 18/617,789

(22) Filed: Mar. 27, 2024

Related U.S. Application Data
(60) Provisional application No. 63/607,888, filed on Dec. 8, 2023.

(51) Int. Cl. H01M 50/249; H01M 50/271; H01M 50/291

(52) U.S. Cl. CPC H01M 50/249; H01M 50/271; H01M 50/291

(57) ABSTRACT

Structural cross-member assemblies are provided for use within traction battery packs. An exemplary traction battery pack may include a cell stack including a plurality of battery cells arranged between a first cross-member assembly and a second cross-member assembly. Each cross-member assembly of the cell stack may include a ladder frame and one or more reinforcement beams mounted to the ladder frame. Each reinforcement beam may be a pultrusion. The pultrusion may be configured to enable the cross-member assembly to react against both tensile loads and compressive loads that act on the cell stack.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to structural cross-member assemblies for use within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a cell stack including a plurality of battery cells arranged between a first cross-member assembly and a second cross-member assembly. The first cross-member assembly and the second cross-member assembly each include a ladder frame and a first reinforcement beam that is mounted to the ladder frame.

In a further non-limiting embodiment of the foregoing traction battery pack, the first reinforcement beam is a pultruded beam structure.

In a further non-limiting embodiment of either of the foregoing traction battery packs, the pultruded beam structure includes an E-shaped, an M-shaped, a W-shaped, or a C-shaped cross-section.

In a further non-limiting embodiment of any of the foregoing traction battery packs, the ladder frame includes a first engagement feature that is configured to interdigitate with a second engagement feature of the first reinforcement beam.

In a further non-limiting embodiment of any of the foregoing traction battery packs, the first engagement feature includes a first finger that is received within a first slot of the second engagement feature. The second engagement feature includes a second finger received within a second slot of the first engagement feature.

In a further non-limiting embodiment of any of the foregoing traction battery packs, the second engagement feature includes an E-shaped cross-section.

In a further non-limiting embodiment of any of the foregoing traction battery packs, an end cap is mounted to an end of the first reinforcement beam.

In a further non-limiting embodiment of any of the foregoing traction battery packs, the end cap includes a third engagement feature that is configured to interdigitate with the second engagement feature.

In a further non-limiting embodiment of any of the foregoing traction battery packs, the ladder frame includes an integrally formed fastener housing.

In a further non-limiting embodiment of any of the foregoing traction battery packs, a fastener insert is received within the fastener housing and is configured to receive a fastener.

In a further non-limiting embodiment of any of the foregoing traction battery packs, a second reinforcement beam is mounted to the ladder frame.

In a further non-limiting embodiment of any of the foregoing traction battery packs, the first reinforcement beam establishes a first pultrusion of the first cross-member assembly or the second cross-member assembly. The second reinforcement beam establishes a second pultrusion of the first cross-member assembly or the second cross-member assembly.

In a further non-limiting embodiment of any of the foregoing traction battery packs, the first reinforcement beam is mounted to an upper portion of the ladder frame, and the second reinforcement beam is mounted to a lower portion of the ladder frame.

A traction battery pack according to another exemplary aspect of the present disclosure includes, among other things, a cross-member assembly including a ladder frame, a first reinforcement beam mounted to the ladder frame, and a second reinforcement beam mounted to the ladder frame.

In a further non-limiting embodiment of the foregoing traction battery pack, the first reinforcement beam establishes a first pultrusion of the cross-member assembly, and the second reinforcement beam establishes a second pultrusion of the cross-member assembly.

In a further non-limiting embodiment of either of the foregoing traction battery packs, the first reinforcement beam establishes an upper plateau of the cross-member assembly, and the second reinforcement beam establishes a lower base of the cross-member assembly.

In a further non-limiting embodiment of any of the foregoing traction battery packs, an adhesive is applied to the upper plateau and to the lower base.

In a further non-limiting embodiment of any of the foregoing traction battery packs, a first end cap is mounted to an end of the first reinforcement beam, and a second end cap is mounted to an end of the second reinforcement beam.

In a further non-limiting embodiment of any of the foregoing traction battery packs, a first fastener insert is received within a first fastener housing of the ladder frame, and a second fastener insert is received within a second fastener housing of the ladder frame.

In a further non-limiting embodiment of any of the foregoing traction battery packs, the first reinforcement beam and the second reinforcement beam each include an E-shaped cross-section, an M-shaped cross-section, a W-shaped cross-section, or a C-shaped cross-section.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 illustrates select portions of a cross-member assembly of the traction battery pack of FIG. 2.

FIG. 4 is an exploded view of the cross-member assembly of FIG. 3.

FIG. 5 illustrates an exemplary cross-sectional shape of a reinforcement beam of a cross-member assembly.

FIG. 6 illustrates another exemplary cross-sectional shape of a reinforcement beam of a cross-member assembly.

FIG. 7 illustrates yet another exemplary cross-sectional shape of a reinforcement beam of a cross-member assembly.

FIG. 8 illustrates select portions of another exemplary cross-member assembly.

FIG. 9 is an exploded view of the cross-member assembly of FIG. 7.

### DETAILED DESCRIPTION

This disclosure details structural cross-member assemblies for traction battery packs. An exemplary traction battery pack may include a cell stack including a plurality of battery cells arranged between a first cross-member assembly and a second cross-member assembly. Each cross-member assembly of the cell stack may include a ladder frame and one or more reinforcement beams mounted to the ladder frame. Each reinforcement beam may be a pultrusion. The pultrusion may be configured to enable the cross-member assembly to react against both tensile loads and compressive loads that act on the cell stack. These and other features are discussed in greater detail in the following paragraphs of this detailed description.

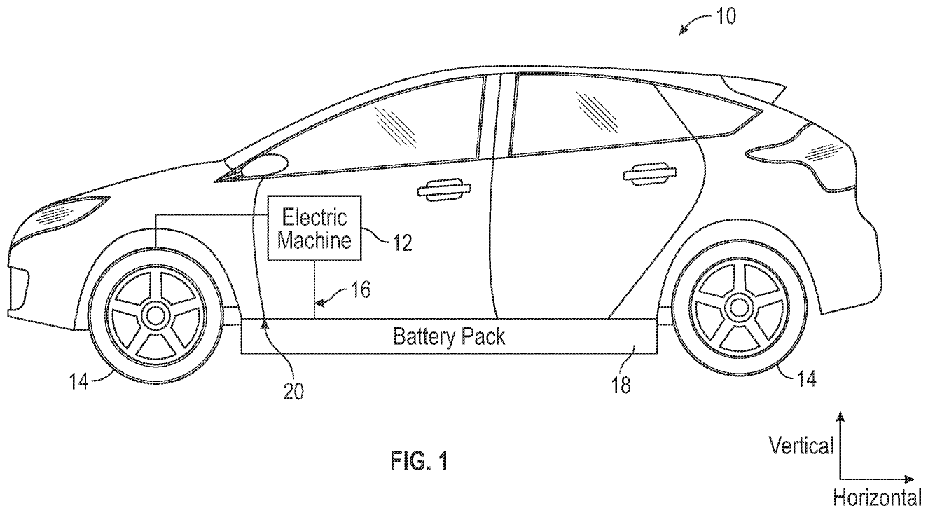

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

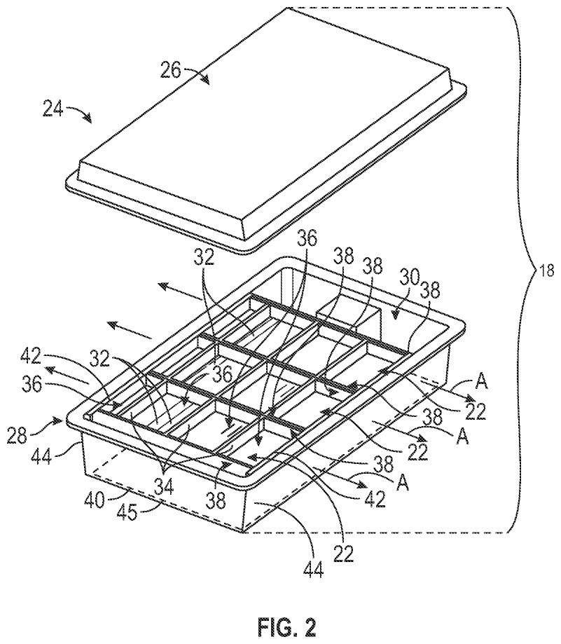

FIG. 2 further illustrates details associated with the traction battery pack 18 of the electrified vehicle 10. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components.

Each cell stack 22 may include a plurality of battery cells 32. The battery cells 32 of each cell stack 22 may be stacked side-by-side relative to one another along a cell stack axis A. The battery cells 32 store and supply electrical power for powering various components of the electrified vehicle 10. Although a specific number of the cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The exemplary battery cells 32 can include tab terminals that project outwardly from a battery cell housing. The tab terminals of the battery cells 32 of each cell stack 22 are connected to one another, such as by one or more busbars, for example, in order to provide the voltage and power levels necessary for achieving vehicle propulsion.

One or more dividers 34 may be arranged along the respective cell stack axis A of each cell stack 22. The dividers 34 may compartmentalize each cell stack 22 into two or more groupings or compartments 36 of battery cells 32. Each compartment 36 may hold one or more of the battery cells 32 of the cell stack 22. In an embodiment, the battery cells 32 of each cell stack 22 are held within one of four compartments 36. However, other configurations, including configurations that utilize a greater or fewer number of compartments 36, could be used within the scope of this disclosure.

The battery cells 32 of each cell stack 22 may be arranged between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 described herein are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 positioned against a floor 45 of the enclosure tray 28. In another embodiment, the heat exchanger plate 40 may be omitted and the vertically lower side of each cell stack 22 may be received in direct contact with the floor 45 of the enclosure tray 28. Vertical and horizontal, for purposes of this disclosure, are with reference to ground and a general orientation of traction battery pack 18 when installed within the electrified vehicle 10 of FIG. 1.

The cross-member assemblies 38 may be adhesively secured to the enclosure cover 26 and to either the heat exchanger plate 40 or the enclosure tray 28 to seal the interfaces between these neighboring components and to structurally integrate the traction battery pack 18.

The cell stacks 22 may be arranged to extend along their respective cell stack axes A between opposing end plates 42. One or more end plates 42 may be positioned between each end of each cell stack 22 and a longitudinally extending side wall 44 of the enclosure tray 28. The end plates 42 may therefore extend along axes that are substantially transverse (e.g. perpendicular) to the cell stack axes A of the cell stacks 22.

In an embodiment, the cell stacks 22 and the cross-member assemblies 38 extend longitudinally in a cross-vehicle direction of the electrified vehicle 10, and the end plates 42 extend longitudinally in a length-wise direction of the electrified vehicle 10. However, other configurations are contemplated within the scope of this disclosure.

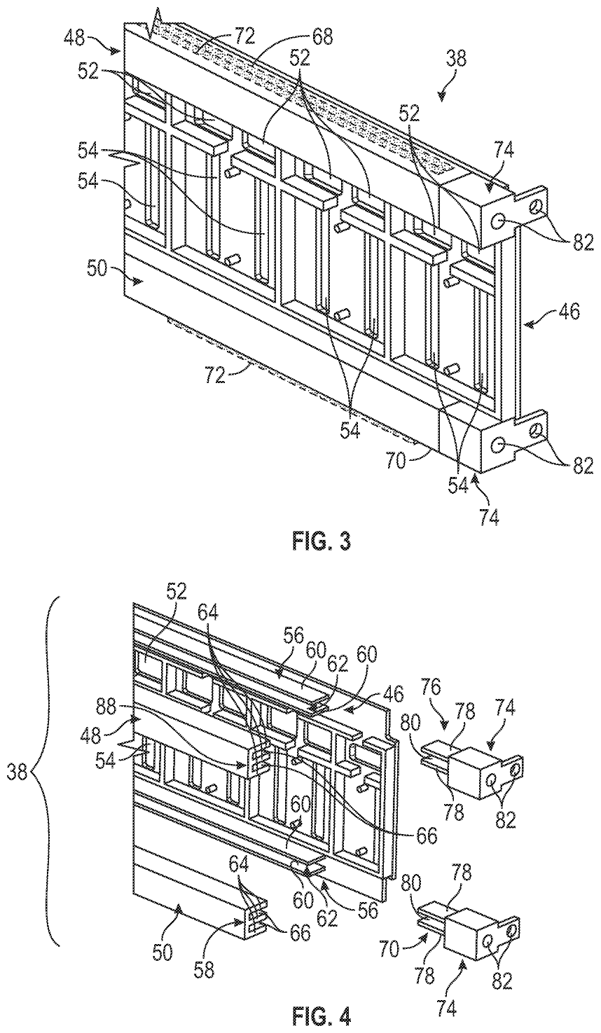

FIGS. 3 and 4 further illustrate details associated with one of the cross-member assemblies 38 of the traction battery pack 18. The additional cross-member assemblies of the traction battery pack 18 could include a substantially identical design to the cross-member assembly 38 shown in FIGS. 3-4.

The cross-member assembly 38 may include a ladder frame 46 and one or more reinforcement sections. In the illustrated embodiment, the cross-member assembly 38 includes an upper or first reinforcement beam 48 and a lower or second reinforcement beam 50. However, other configurations are also contemplated within the scope of this disclosure.

The ladder frame 46 may be either a unitary or multi-piece injection molded structure. The ladder frame 46 may be made of any suitable thermoplastic material.

The ladder frame 46 may include one or more vent openings 52 for communicating battery cell vent byproducts through the ladder frame 46 and into a passageway located between adjacent cell stacks 22. The vent openings 52 may thus provide a pathway for battery cell vent byproducts to move through the cross-member assembly 38 as may be required during a cell venting event, for example.

The ladder frame 46 may additionally include a plurality of cell tab openings 54 arranged vertically below the vent openings 52. The cell tab openings 54 may be elongated slots configured to accommodate the cell tab terminals of the battery cells 32. In an embodiment, each cell tab opening 54 may accommodate one cell tab terminal. In another embodiment, each cell tab opening 54 may be sized to receive cell tab terminals from multiple adjacent battery cells 32.

In an assembled state of the cross-member assembly 38, both the vent openings 52 and the cell tab openings 54 are located between the first and second reinforcement beams 48, 50 (sec, e.g., FIG. 3). However, other configurations are possible within the scope of this disclosure.

The first reinforcement beam 48 and the second reinforcement beam 50 may be mounted at separate locations of the ladder frame 46 for structurally reinforcing the cross-member assembly 38. The ladder frame 46 and the first and second reinforcement beams 48, 50 may include mateable features that facilitate the connection of the first and second reinforcement beams 48, 50 to the ladder frame 46. For example, the ladder frame 46 may include first engagement features 56 that are configured to mesh or interdigitate with a second engagement feature 58 of the first reinforcement beam 48 or the second reinforcement beam 50. In an embodiment, the first engagement features 56 each include a first arrangement of fingers 60 and slots 62, and the second engagement features 58 each include a second arrangement of fingers 64 and slots 66. The fingers 60 of the first engagement features 56 can be received in the slots 66 of the second engagement features 58 and vice versa in order to mount the first and second reinforcement beams 48, 50 to the ladder frame 46. Although not shown, an adhesive could be applied between the first and second engagement features 56, 58 for further facilitating the connection of the first and second reinforcement beams 48, 50 to the ladder frame 46.

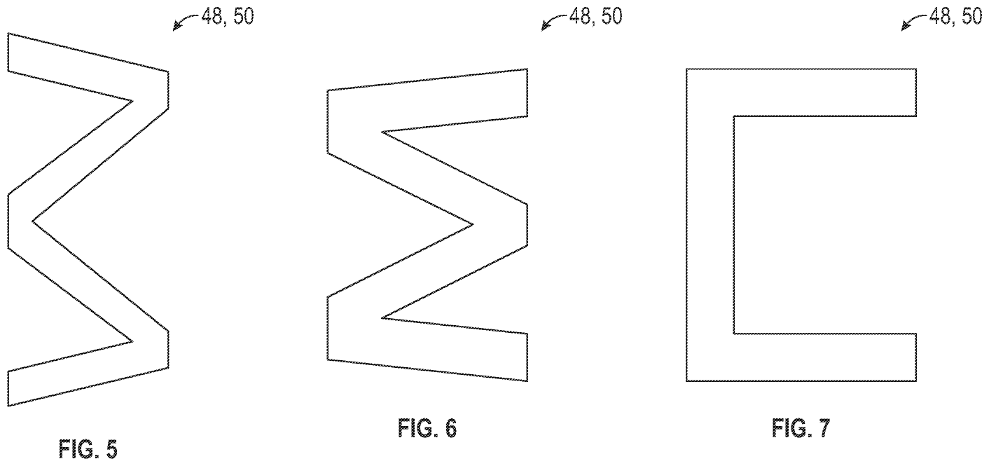

In an embodiment, the second engagement feature 58 of each of the first reinforcement beam 48 and the second reinforcement beam 50 includes an E-shaped cross-section (see FIG. 4). In another embodiment, the second engagement feature 58 of each of the first reinforcement beam 48 and the second reinforcement beam 50 includes an M-shaped cross-section (albeit side oriented, see FIG. 5). In yet another embodiment, the second engagement feature 58 of each of the first reinforcement beam 48 and the second reinforcement beam 50 includes a W-shaped cross-section (albeit side oriented, see FIG. 6). In yet another embodiment, the second engagement feature 58 of each of the first reinforcement beam 48 and the second reinforcement beam 50 includes a C-shaped cross-section (see FIG. 7). However, other cross-sectional shapes are contemplated within the scope of this disclosure.

In an embodiment, the first and second reinforcement beams 48, 50 are pultrusions, which implicates structure to these beam-like structures. A person of ordinary skill in the art having the benefit of this disclosure would understand how to structurally distinguish a pultruded beam structure from another type of structure, such as an extruded beam, for example.

The first and second first reinforcement beams 48, 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the first and second first reinforcement beams 48, 50.

When mounted to the ladder frame 46, the first reinforcement beam 48 may establish an upper plateau 68 of the cross-member assembly 38, and the second reinforcement beam 50 may establish a lower base 70 of the cross-member assembly 38. An adhesive 72 (see FIG. 3) may be applied to the upper plateau 68 and to the lower base 70 for securing the cross-member assembly 38 directly to the enclosure cover 26 and to either the heat exchanger plate 40 or the enclosure tray 28, respectively. The cell stacks 22 may therefore be structurally integrated with the enclosure assembly 24 of the traction battery pack 18.

An end cap 74 may be secured to each end of each of the first reinforcement beam 48 and the second reinforcement beam 50. Accordingly, in the illustrated embodiment, the cross-member assembly 38 can include a total of four end caps 74. However, other configurations are contemplated within the scope of this disclosure. In an embodiment, each end cap 74 is constructed from a metallic material (e.g., aluminum, etc.).

Each end cap 74 may include mateable features that facilitate its connection to either the first reinforcement beam 48 or the second reinforcement beam 50. For example, each end cap 74 may include a third engagement feature 76 (see FIG. 4) that is configured to mesh or interdigitate with the second engagement feature 58 of the first reinforcement beam 48 or the second reinforcement beam 50. In an embodiment, the third engagement feature 76 is similar to the first engagement feature 56 of the ladder frame 46 and thus may include a third arrangement of fingers 78 and slots 80. The fingers 78 of the third engagement feature 76 can be received in the slots 66 of the second engagement feature 58 and vice versa in order to mount the end cap 74 to the first reinforcement beam 48 or the second reinforcement beam 50.

Each end cap 74 may additionally include one or more fastener openings 82. Each fastener opening 82 is configured to receive a fastener (e.g., bolt, screw, etc.) for mounting the cross-member assembly 38, and thus the cell stack 22, to a neighboring structure, such as one of the end plates 42 of the traction battery pack 18 shown in FIG. 2, for example. The fastener (not shown) may be passed through the end plate 42 and then be accommodated within one of the fastener openings 82 for mounting the cell stack 22 to the end plate 42. This connection can help contain tensile loads that can occur over the life of the cell stack 22 as a result of battery cell expansion forces while also allowing for side forces to be distributed over a larger area when compressive forces act on the traction battery pack along the direction of the cell stack axis A.

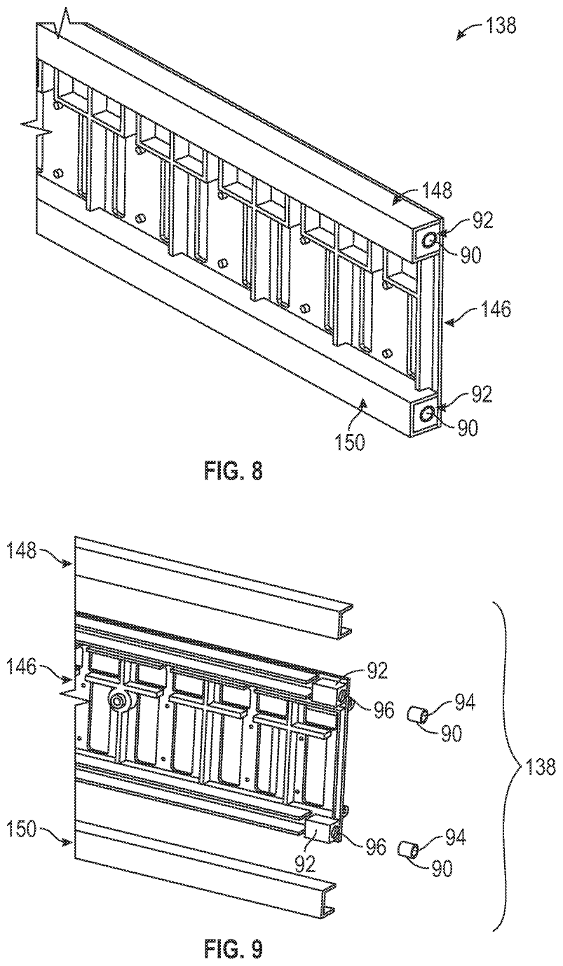

FIGS. 8 and 9 illustrate another exemplary cross-member assembly 138 that can be utilized as part of a cell stack within a traction battery pack. The cross-member assembly 138 is similar to the cross-member assembly 38 discussed above and thus may include a ladder frame 146 and a first reinforcement beam 148 and a second reinforcement beam 150 that can be mounted to the ladder frame 146. However, in this implementation, the end caps 74 can be eliminated from the cross-member assembly design and be replaced by fastener inserts 90. The fastener inserts 90 may be made of a thermoset material, for example.

Each fastener insert 90 may be received within an opening 96 provided by a fastener housing 92 of the ladder frame 146. In an embodiment, the fastener housings 92 are integrally formed (e.g., molded) features of the ladder frame 146. The first reinforcement beam 148 and the second reinforcement beam 150 may be shaped to accommodate the fastener housings 92.

Each fastener insert 90 may include a fastener opening 94 that is configured to receive a fastener (e.g., a bolt or screw, not shown) for mounting the cross-member assembly 138 and thus an associated cell stack to a neighboring structure, such as one of the end plates 42, for example. The fastener may be passed through the end plate 42 and can then be accommodated within the fastener opening 94 of the fastener insert 90 for mounting the cell stack 22 to the end plate 42. This connection can help contain tensile loads that can occur over the life of the cell stack 22 as a result of battery cell expansion forces.

The exemplary cross-member assemblies of this disclosure provide enhanced structural integrity over known battery cross-members by providing both tensile and compression load capability. Incorporating reinforcement beams such as pultrusions into the cross-member assembly increases strength and provides for the ability to manufacture more complex shapes, thereby permitting traction battery pack assembly to be achieved with less overall parts and less complexity.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a cell stack including a plurality of battery cells arranged between a first cross-member assembly and a second cross-member assembly; and
the first cross-member assembly and the second cross-member assembly each including a ladder frame and a first reinforcement beam that is mounted to the ladder frame.

2. The traction battery pack as recited in claim 1, wherein the first reinforcement beam is a pultruded beam structure.

3. The traction battery pack as recited in claim 2, wherein the pultruded beam structure includes an E-shaped, an M-shaped, a W-shaped, or a C-shaped cross-section.

4. The traction battery pack as recited in claim 1, wherein the ladder frame includes a first engagement feature that is configured to interdigitate with a second engagement feature of the first reinforcement beam.

5. The traction battery pack as recited in claim 4, wherein the first engagement feature includes a first finger that is received within a first slot of the second engagement feature, and further wherein the second engagement feature includes a second finger received within a second slot of the first engagement feature.

6. The traction battery pack as recited in claim 5, wherein the second engagement feature includes an E-shaped cross-section.

7. The traction battery pack as recited in claim 4, comprising an end cap mounted to an end of the first reinforcement beam.

8. The traction battery pack as recited in claim 7, wherein the end cap includes a third engagement feature that is configured to interdigitate with the second engagement feature.

9. The traction battery pack as recited in claim 1, wherein the ladder frame includes an integrally formed fastener housing.

10. The traction battery pack as recited in claim 9, comprising a fastener insert received within the fastener housing and configured to receive a fastener.

11. The traction battery pack as recited in claim 1, comprising a second reinforcement beam mounted to the ladder frame.

12. The traction battery pack as recited in claim 11, wherein the first reinforcement beam establishes a first pultrusion of the first cross-member assembly or the second cross-member assembly, and the second reinforcement beam establishes a second pultrusion of the first cross-member assembly or the second cross-member assembly.

13. The traction battery pack as recited in claim 11, wherein the first reinforcement beam is mounted to an upper portion of the ladder frame, and the second reinforcement beam is mounted to a lower portion of the ladder frame.

14. A traction battery pack, comprising:
a cross-member assembly including:
a ladder frame;
a first reinforcement beam mounted to the ladder frame; and
a second reinforcement beam mounted to the ladder frame.

15. The traction battery pack as recited in claim 14, wherein the first reinforcement beam establishes a first pultrusion of the cross-member assembly, and the second reinforcement beam establishes a second pultrusion of the cross-member assembly.

16. The traction battery pack as recited in claim 14, wherein the first reinforcement beam establishes an upper plateau of the cross-member assembly, and the second reinforcement beam establishes a lower base of the cross-member assembly.

17. The traction battery pack as recited in claim 16, comprising an adhesive applied to the upper plateau and to the lower base.

18. The traction battery pack as recited in claim 14, comprising a first end cap mounted to an end of the first reinforcement beam, and a second end cap mounted to an end of the second reinforcement beam.

19. The traction battery pack as recited in claim 14, comprising a first fastener insert received within a first fastener housing of the ladder frame, and a second fastener insert received within a second fastener housing of the ladder frame.

20. The traction battery pack as recited in claim 14, wherein the first reinforcement beam and the second reinforcement beam each include an E-shaped cross-section, an M-shaped cross-section, a W-shaped cross-section, or a C-shaped cross-section.
